(19) United States
(12) Patent Application Publication
(10) Pub. No.: US 2011/0217415 A1
(43) Pub. Date: Sep. 8, 2011

(54) Hybrid fermentation process

(75) Inventors: Jennifer A. Danehy, Memphis, TN (US); D. Christopher Romer, Memphis, TN (US); James Pope, Cordova, TN (US); Michael Buckland, Casselberry, FL (US); Peter Poetschacher, Vienna (AT)

(73) Assignee: Lurgi, Inc., Memphis, TN (US)

(21) Appl. No.: 12/887,002

(22) Filed: Sep. 21, 2010

Related U.S. Application Data
(60) Provisional application No. 61/310,969, filed on Mar. 5, 2010.

(51) Int. Cl. C12C 11/07

(52) U.S. Cl. 426/13; 426/11

(57) ABSTRACT

A hybrid fermentation process for the production of; fermentation products is provided. This process includes combining a saccharide-rich slurry. This saccharide-rich slurry may include, but is not limited to starch, cellulose, hemi-cellulose, cellulobios, and may or may not contain, proteins, peptides, amino acids, lignin and to other biologically produced or environmental compounds. The process also includes a fermenting organism such as yeast, bacteria, archea, algae or other biocatalyst. The process also includes nutrients for the fermenting organism in a continuous fermentation step, thereby producing a partially fermented stream. The process also includes introducing the partially fermented product stream into a batch fermentation step, thereby producing a finished fermented beer stream.

This application claims the benefit of U.S. Provisional Application No. 61/310,969, filed Mar. 5, 2010, the entire contents of which are incorporated herein by reference.

### BACKGROUND

The corn ethanol and sugar to ethanol industries are once again expanding production capacity to meet slowly increasing demand while continuing to improve on operating cost margins. Individually, fuel ethanol corn dry mills and sugar mills are targeting improvements to productivity and operating efficiency. Process enhancements and new technologies are being implemented to meet these goals.

Fermentation is a key process step in the production of ethanol, and in the near future “drop in” fuels. Improving the fermentation efficiency gives a direct benefit to increased throughput, higher production rate, and better operating efficiency. All of these can result in greater revenue and lower production costs per gallon of ethanol produced. These selling points make the new high performance fermentation process, or “hybrid fermentation”, attractive.

The process for producing ethanol from cereal grains, such as corn, involves the key step of fermentation. Following the pretreatment of the grain and conversion of the starch in the grain to dextrins then sugars, the mash stream is processed by fermentation resulting in the beer stream. Basically, the fermentation process uses yeast to convert sugars to ethanol and carbon dioxide.

There are currently several variations on the fermentation process design, including, but not limited to:
Batch fermentation,
Continuous fermentation,
Simultaneous saccharification and fermentation (SSF),
Separate hydrolysis and fermentation (SHF).

Each fermentation process arrangement has relative advantages and disadvantages. For the fuel ethanol corn dry mill (1^{st} generation) in the United States, batch fermentation in a simultaneous saccharification and fermentation (SSF) arrangement is typically preferred.

The traditional 1^{st} generation ethanol dry mill processes cereal grains, such as corn, through units of milling, hydrolysis (including mash preparation, cook, and liquefaction), fermentation (SSF), and ethanol recovery (distillation and dehydration). FIG. 1 diagrams the traditional ethanol dry mill process flow.

Processing upstream of fermentation has a significant influence on fermentation performance. The ability and yield for yeast to convert sugar to ethanol relies on availability of sugar and controlling stress factors: maximizing the conversion of starch to sugars, cooling to an appropriate temperature, reducing infection-based losses in starch and sugars, minimizing infection-based inhibitors or feedstock-based toxins, maintaining an optimal solids and sugar concentration, and reaching an optimal ethanol concentration. These considerations may be addressed in the following way.

Size reduction using hammermills prepares the grain or corn kernel for hydrolysis by exposing the endosperm and starch. A balance is typically drawn in a U.S. operating plant between particle size that is small enough to provide good yields, particle size that is large enough to retain good separation at the stillage decanter centrifuges, good particle size for the dried distillers grains co-product, and reasonable electrical energy use at the hammermills.

During mash preparation, the initial solids concentration is established as slurry in water. Gelatinization of the starch occurs, and alpha-amylase enzyme is added to start the conversion of starch to soluble dextrins while rapidly reducing the high viscosities produced at the gelatinization temperatures. The trend in the U.S. dry mill has typically been to increase the solids concentration, while the alpha-amylase use is heavily dependent on the enzyme manufacturer's developments and recommendations.

The traditional addition of alpha-amylase is in two separate doses, ⅓ to ½ of the total dose at this mash prep and the final ½ to % at liquefaction. The split alpha-amylase dose is due to enzyme inactivation at the high temperatures of the jet cook process step (221° to 225° F.). More recent process developments in some ethanol dry mills have eliminated the high-temperature cook step, preventing the alpha-amylase inactivation. Elimination of the high-temperature cook step is more consistent with a high-performance fermentation. An industrial scale design criteria can be with or without the jet cook or high temperature cook.

The solids concentration selection at mash prep helps determine the eventual sugars or fermentable matter concentration at fermentation. The fermentable matter concentration is critical because higher values give improved fermentation efficiency but concentrations that are too high can stress the yeast and can develop viscosities that are difficult to process. These limits to fermentable matter and solids concentration are important to the feasibility of a “Hybrid Fermentation” upgrade to an existing dry mill, as is one embodiment of the invention herein. Many corn dry mill operations in the U.S. have not yet accepted higher solids greater than 30% by weight. However, higher solids of approximately 33% by weight will result in a higher fermentable matter that takes fuller advantage of the proposed “Hybrid Fermentation” improvements. Taking greater advantage of these improvements makes the economics and payback of the upgrade more attractive.

Operation at a higher solids concentration is dependent on the resulting viscosity, the capability of existing equipment, the enzyme tolerance to higher solids, and yeast stress factors related to high gravity fermentations. Each application must be evaluated to determine enzyme limitations, availability of additional alpha-amylase dosing or more advanced enzymes to reduce viscosity, and equipment capacity capabilities for handling higher viscosity and specific gravity.

Fermentation, where the final conversion to ethanol takes place, is conducted as batch fermentation and simultaneous saccharification and fermentation (SSF) in the traditional fuel ethanol corn dry mill in the United States. With each batch fermenter, the conversion of dextrins to sugars (saccharification) and the conversion of sugars to ethanol and carbon dioxide (fermentation) occur. Glucoamylase enzyme, yeast, urea, and other nutrients are also added to each fermenter fill. Yeast propagation is conducted in a separate tank for each fermentation batch.

While a simultaneous saccharification and fermentation technique is the common practice for batch production of ethanol in the United States, it introduces its own variability in the process that requires nearly constant adjustment to the downstream processing because of variable alcohol yields from batch to batch. For both the continuous and the batch fermentation processes, hydrolysis is used to prepare the mash by partially breaking down the polysaccharides into small enough units to prepare the feedstock for final breakdown in the fermentation vessel. A separate pre-saccharification prior to fermentation is also practical with proper precautions to minimize infections.

Traditionally to maximize access to the feedstock in the case of dry mill corn to ethanol, the Genencor Fermenzyme® L-400 enzyme often used for bench-scale saccharification tests is a Glucoamylase and Protease blend for simultaneous starch and protein hydrolysis. Even though the protease is an added operating expense that can improve overall performance, the fermentation efficiency improvement demonstrated with the proposed “hybrid fermentation” process is independent of the protease enzyme use. A typical glucoamylase, without the protease, is acceptable for use with the proposed “hybrid fermentation.”

Ethanol concentration in the fermenter is a critical operating parameter in optimizing throughput capacity and ethanol conversion yield. A typical industry design criteria is 10.5 wt % ethanol at the end of each fermentation batch. However, many dry mills have improved on this criterium improving both throughput and yield.

To inhibit bacterial growth, prevent sugar losses, reduce yeast inhibitors formation, and improve ethanol yield, many dry mills are using antimicrobial additives. One common antimicrobial in the U.S. fuel ethanol industry is Lactrol, with a virginiamycin active ingredient, by PhibroChem.

Because of the potential for infection issues of the separate pre-saccharification tank operating at 140° F. (60° C.), the antimicrobial strategy for the operation must incorporate this tank. In addition, the CIP strategy for the proposed “hybrid fermentation” arrangement must be considered. Traditional ethanol production using batch fermentation includes the CIP of fermenters within the batch steps, therefore minimizing upsets to the overall process flow through the system. At the end of each batch, the fermenter is drained and cleaned within the total time allocated for each batch fermenter. With a continuous fermenter, a shutdown is required on a periodic basis, approximately every 4 to 6 months, to clean the fermenter equipment.

A new fermentation process is herein proposed that takes advantage of the benefits of both continuous and batch fermentation. Separate hydrolysis and fermentation or a pre-saccharification step is utilized, followed by simultaneous saccharification and fermentation.

### SUMMARY

A hybrid fermentation process for the production of fermentation products is proposed. This process includes processing a saccharide-rich slurry. This saccharide-rich slurry may include, but is not limited to starch, cellulose, hemi-cellulose, cellulobios, and may or may not contain, proteins, peptides, amino acids, lignin and to other biologically produced or environmental compounds. The process also includes a fermenting organism such as yeast, bacteria, archea, algae or other biocatalyst. The process also includes nutrients for the fermenting organism in a continuous fermentation step, thereby producing a partially fermented stream. The process also includes introducing the partially fermented product stream into a batch fermentation step, thereby producing a finished fermented beer stream.

### BRIEF DESCRIPTION OF THE FIGURES

FIG. 1 illustrates a typical example of a traditional grain ethanol dry mill process flow.

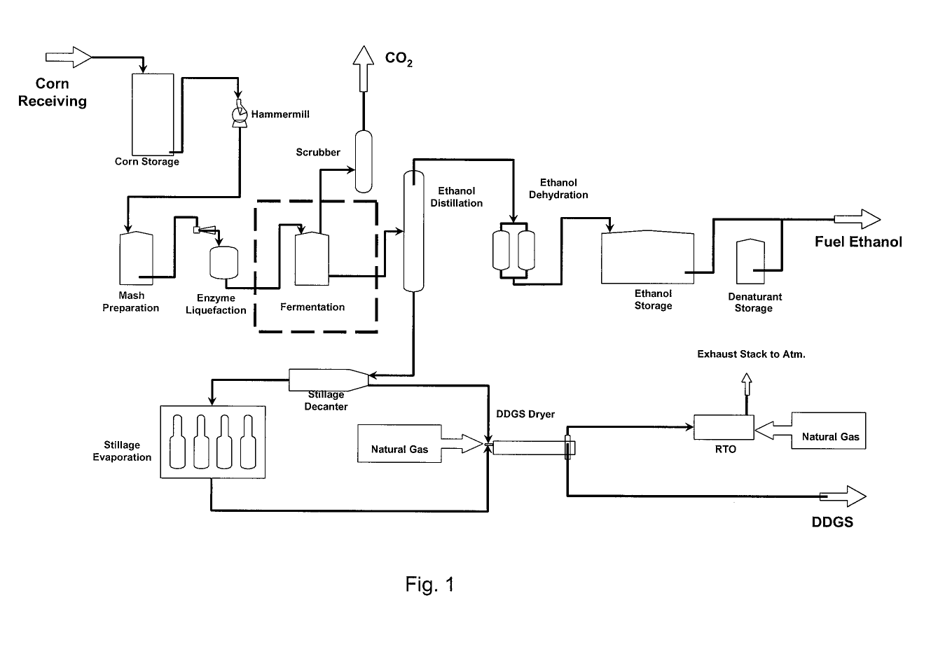

FIG. 2 illustrates details of one embodiment of the present invention.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

An improved arrangement takes advantage of the strengths of continuous fermentation and batch fermentation, while attempting to avoid the drawbacks of each. The primary advantage for batch fermentation is higher alcohol concentration in the beer (the product stream from fermentation). The disadvantages for batch fermentation are instability at the start of a batch (requiring use of antimicrobials), inconsistencies introduced at the start of the batch that lead to inconsistent final product from batch to batch which upset downstream processing and loss of productivity at the beginning of a batch. The primary advantage of a continuous fermenter is higher infection stability from the beginning and higher productivity at the beginning. The disadvantage for continuous is poor productivity at the end of a fermentation resulting in lower ethanol in the beer.

The proposed solution is to have the first fermenter running as continuous, finishing in multiple batch tanks. In this way, the advantages of continuous and batch are combined:
High alcohol concentration,
No antimicrobials,
No yeast propagators.
More consistent fermentation products.

The first tank operating in continuous mode may have 30% to 70% of the total activitiy, more preferably 40% to 60% of the total activity, more preferably 50% of the total activity and therefore would need the biggest heat exchanger for cooling. All the other tanks (operating in batch mode) would need smaller heat exchangers and also smaller pumps.

Yeast addition to the “hybrid fermentation” would take place at startup and first-fill to the continuous fermentation tank. This initial inoculation of yeast propagates (“building-up”) in the continuous fermentation tank to reach an adequate concentration after about 10 hours. After a minimum time of 20 hours, steady state conditions are met in the continuous fermentation tank. In actual operation, a time of 30 hours might be selected for satisfying steady state conditions and moving forward to the batch fermenters to allow for differences in the industrial scale and operational uncertainties.

The quantity of yeast for initial inoculation of the continuous fermentation tank at first-fill would not be a set number or important selection. The propagation or building-up process in the continuous fermentation tank makes up for any initial inoculation differences. Under ideal conditions, additional yeast should not be required until the next continuous fermentation tank fill and startup. This fill may occur every 4 to 6 months based on CIP shutdown intervals. Because the initial inoculation and building-up of yeast takes place in the continuous fermentation tank, separate propagation tank(s) are not required.

Due to the very high fermentive activity in the first tank (the continuous fermentation tank), a pre-saccharification tank will typically be required of sufficient capacity to allow time for breakdown of the feedstock to provide disaccharides, trisaccharides, tetrasaccharides pentasaccharides, etc, to meet the needs of the fermentation organism via final breakdown into simple sugars using enzymatic means within the continuous fermenter. The pre-saccharification tank will operate at between 120° F. to 200° F., more preferably between 130° F. and 160° F., more preferably, between 135° F. and 145° F. and most preferably at 140° F. (60° C.) with current economic enzyme technology. This tank will be monitored and addressed as part of the operation's antimicrobial strategy. In addition, if the mix tank (mash prep) is operating at the typical pH of 5.5 to 6.0, then pH adjustment of between 2 to 6, more preferably between 3 and 5 and more preferably between 4 and 4.5 may be required as operationally condusive to optimize enzyme activity and provide a relatively inhospitable environment for biological contamination . . . .

The separate pre-saccharification; breakdown to between 30 and 70 Dextrose Equivalent (DE), more preferably to between 40 and 60 DE, and more preferably to a 50 DE; optimally benefits the continuous fermentation operation. Operating a separate pre-saccharification tank operating at 140° F. (60° C.) and a pH of between 2 to 6, more preferably between 3 and 5 and more preferably between 4 and 4.5 provides a relatively inhospitable environment for biological contamination that could compete in the fermentation environment. Additional treatments are available to minimize potential infections issues.

The only new component would be the “batch finishing” which has very low risk because the yeast is formed and sufficient alcohol to give a disinfecting effect toward other biological activity already in the first fermenter.

An important parameter of the process is the solids concentration and fermentable matter concentration. Higher solids are needed to take full advantage of the improved fermentation yield and productivity. The bench-scale lab testing indicates a solids concentration of approximately 33% by weight and varied fermentable matter of 19.4% to 23.7% with 21.6% fermentable matter giving the target results. The targeted fermentation efficiency improvements are 1.5% minimum.

As used herein, a saccharide is defined as the unit structure of carbohydrates, of general formula CnH2nOn; either the simple sugars, pairs known as dissaccharides, triplets known as trisaccharides, quartets known as tetrasaccharides, up to longer chains and polymers such as starch, hemicellulose, and cellulose. The basic units of saccharides exist in either a ring or short chain conformation, and typically contain five or six carbon atoms.

As used herein, a beer is defined as the discharge stream from a fermentation process that comprises the product(s) of fermentation and may or may not contain the residual raw materials fed to the fermentation process, as well as the fermenting organisim.

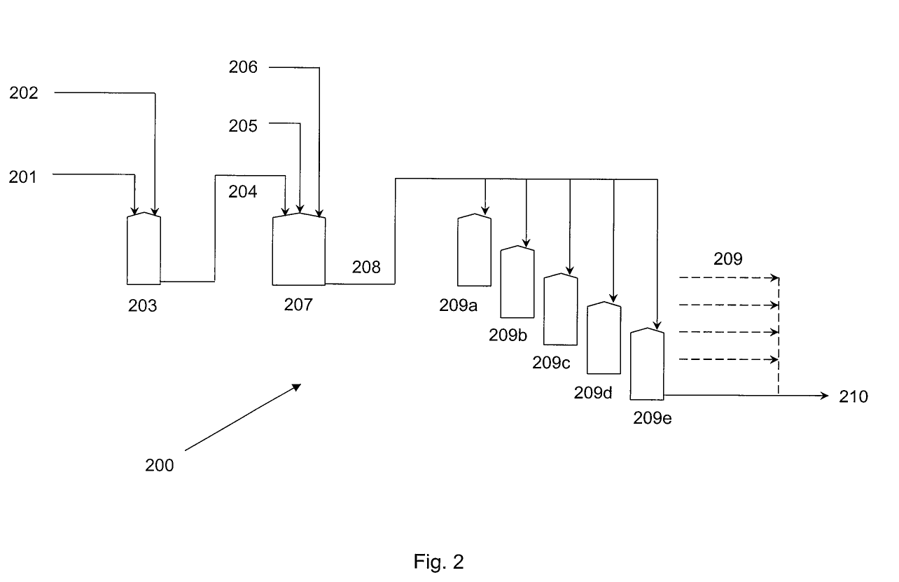

Referring now to FIG. 2, an improvement to the traditional fermentation process is disclosed. The improved process 200 takes advantage of the strengths of continuous fermentation 207 and batch fermentation 209, while attempting to avoid the drawbacks of each.

The primary advantage for batch fermentation is higher product titer (for example in the case of corn to ethanol is higher alcohol concentration in the beer. The disadvantages for batch fermentation are instability at the start of a batch (requiring use of antimicrobials) and loss of productivity at the beginning of a batch. The primary advantage of a continuous fermenter is higher infection stability from the beginning and higher productivity at the beginning. The disadvantage for continuous is lower titer due to the limits required to retain viability of the fermenting organism at the end of a fermentation resulting for example in the case of corn to ethanol in lower ethanol concentration in the beer.

The present invention has the first fermenter 207 running in a continuous manner, then introducing the partially fermented stream into multiple batch tanks 209a-209e for finishing. The number of actual tanks depends upon the overall throughput of the system. In this way, the advantages of continuous and batch are combined:
Higher product concentration,
Reduced probability for infection,
Reduction in fermentation time to reach objective compared to batch alone.
More consistent fermentation products.

The first tank 207 operating in continuous mode has much of the total activity and therefore needs the biggest heat exchanger for cooling (not shown) in the case of an exothermic fermentation, and for heating in the case of an endothermic fermentation. All the other tanks (operating in batch mode) need smaller heat exchangers and also smaller pumps (not shown).

Fermenting Organism, Yeast addition for example in the case of starch to ethanol, to process 200 takes place at startup and first-fill to the continuous fermentation tank 207. This initial inoculation of yeast propagates (“building-up”) in the continuous fermentation tank 207 to reach an adequate concentration after 10 hours. After a minimum time of 20 hours, steady state conditions are met in the continuous fermentation tank. In actual operation, a time of 30 hours would be selected for satisfying steady state conditions and moving forward to the batch fermenters to allow for differences in the industrial scale and operational uncertainties.

The quantity of fermenting organisms, for example yeast in the case of starch to ethanol for initial inoculation of the continuous fermentation tank at first-fill is not a set number or important selection. The propagation or building-up process in the continuous fermentation tank makes up for any initial inoculation differences. Under ideal conditions, additional fermentation organisms, for example yeast in the case of starch to ethanol should not be required until the next continuous fermentation tank fill and startup. This fill may occur every 4 to 6 months based on CIP (clean in place) shutdown intervals. Because the initial inoculation and building-up of fermenting organisms, such as yeast by example for starch to ethanol, takes place in the continuous fermentation tank 207, separate propagation tank(s) are not required.

Due to the very high activity in the first tank 207 (the continuous fermentation tank), a pre-saccharification is required in tank 203. The pre-saccharification tank 203 operating between 120° F. to 200° F., more preferably between 130° F. and 160° F., more preferably, between 135° F. and 145° F. and most preferably at 140° F. (60° C.) will be monitored and addressed as part of the operation's antimicrobial strategy. In addition, if the mix tank (mash prep, not shown) is operating at the typical pH of 5.5 to 6.0, then pH adjustment of between 2 to 6, more preferably between 3 and 5 and more preferably between 4 and 4.5 may be required as operationally condusive to optimize enzyme activity and provide a relatively inhospitable environment for biological contamination.

A key parameter of the current process is the solids concentration and fermentable matter concentration. Higher solids are needed to take full advantage of the improved fermentation yield and productivity. The bench-scale lab testing indicates a solids concentration of approximately 33% by weight and varied fermentable matter of 19.4% to 23.7% with 21.6% fermentable matter giving the target results. The targeted fermentation efficiency improvements are 1.5% minimum.

One embodiment of the current invention may be described as follows. A liquefied mash stream, produced by the milling of corn and mixing it into hot water, 201 is combined with a saccharification enzyme 202 in a pre-saccharification tank 203, thereby producing a multi-saccharide-rich slurry 204. Liquefied mash stream 201 may be more than just a corn mash stream and have a solids concentration from less than to greater than about 30% by weight. Liquefied mash stream 201 may be more than have a solids concentration between about 30% and about 40% by weight. Liquefied mash stream 201 may have a solids concentration of about 33% by weight Saccharification enzyme 202 may be glucoamylase. This multi-saccharide-rich slurry 204 is then combined with a fermenting organism stream 205 and a fermenting organism nutrient stream 206 in a continuous fermentation tank 207, thereby producing a fermented product stream 208. In the case of yeast, the nutrient stream 206 is typically urea. This fermented product stream 208 is then introduced into two or more batch fermentation tanks 209, thereby producing a fully fermented beer stream 210.

What is claimed is:

1: A hybrid fermentation process for the production of; fermentation products comprising:
a) combining a multi-saccharide-rich slurry including but not limited to starch, cellulose, hemi-cellulose, cellulobios, and may or may not contain, proteins, peptides, amino acids, lignin and to other biologically produced or environmental compounds, a fermenting organism such as yeast, bacteria, archea, algae or other biocatalyst, and nutrients for said fermenting organism in a continuous fermentation step, thereby producing a partially fermented stream; and
b) introducing said partially fermented product stream into a batch fermentation step, thereby producing a finished fermented beer stream.

2: The hybrid fermentation process of claim 1, further comprising
a′) combining a liquefied or partially liquefied mash and a saccharification enzyme in a pre-saccharification step thereby producing said multi-saccharide-rich slurry;

3: The hybrid fermentation process of claim 2, wherein said saccharification enzyme is a set of glycoside hydrolases which may include, but is not limited to any one or a combination of, amylase, lactase, chitinase, sucrase, maltase, neuraminidase, invertase, hyaluronidase lysozyme, xylanase or cellulobiase

4: The hybrid fermentation process of claim 2, wherein said liquefied or partially liquefied mash has a solids concentration of less than or greater than about 30% by weight.

5: The hybrid fermentation process of claim 2, wherein said liquefied or partially liquefied mash has a solids concentration of between about 30% and about 40% by weight.

6: The hybrid fermentation process of claim 2, wherein said liquefied or partially liquefied mash has a solids concentration more preferably between 32% and 35% by weight.

7: The hybrid fermentation process of claim 2, wherein said pre-saccarification results in a breakdown to between 30 and 70 dextrose equivalent.

8: The hybrid fermentation process of claim 7, wherein said pre-saccarification results in a breakdown to between 40 and 60 dextrose equivalent.

9: The hybrid fermentation process of claim 7, wherein said pre-saccarification results in a breakdown to 50 dextrose equivalent.

10: The hybrid fermentation process of claim 2, wherein said pre-saccarification operates at a pH of between 2 and 6.

11: The hybrid fermentation process of claim 10, wherein said pre-saccarification operates at a pH of between 3 and 5.

12: The hybrid fermentation process of claim 10, wherein said pre-saccarification operates at a pH of between 4 and 4.5.

13: The hybrid fermentation process of claim 2, wherein said pre-saccarification operates at a temperature of between 120 F and 200 F.

14: The hybrid fermentation process of claim 13, wherein said pre-saccarification operates at a temperature of between 130 F and 160 F.

15: The hybrid fermentation process of claim 13, wherein said pre-saccarification operates at a temperature of between 135 F and 145 F.

16: The hybrid fermentation process of claim 13, wherein said pre-saccarification operates at a temperature of 140 F.

17: The hybrid fermentation process of claim 1, wherein said fermentation organism is yeast and the nutrient is urea.

18: The hybrid fermentation process of claim 1, wherein said batch fermentation step further comprises the sequential introduction of said partially fermented product stream into at least two batch fermentation tanks.

19: The hybrid fermentation process of claim 1, wherein antimicrobials can be reduced or eliminated.

20: The hybrid fermentation process of claim 1, wherein said continuous process completes between 30% and 70% of the overall fermentation.

21: The hybrid fermentation process of claim 16, wherein said continuous process completes between 40% and 60% % of the overall fermentation

22: The hybrid fermentation process of claim 16, wherein said continuous process completes more than 50% of the overall fermentation
